(19) United States
(12) Patent Application Publication
(10) Pub. No.: US 2012/0154625 A1
(43) Pub. Date: Jun. 21, 2012

(54) IMAGE PROCESSING APPARATUS, IMAGE PROCESSING METHOD, AND PROGRAM RECORDING MEDIUM

(75) Inventor: Tsuyoshi MORIYA, Yokohama-shi (JP)

(73) Assignee: Samsung Electronics Co., Ltd., Suwon-si (KR)

(21) Appl. No.: 13/324,485

(22) Filed: Dec. 13, 2011

(30) Foreign Application Priority Data
Dec. 15, 2010 (JP) 279790/2010
Nov. 25, 2011 (KR) 10-2011-0124427

(51) Int. Cl. H04N 9/73; H04N 5/228

(52) U.S. Cl. 348/223.1; 348/222.1; 348/E09.051

(57) ABSTRACT

An image processing apparatus, an image processing method, and a program recording medium are provided. The image processing apparatus includes a color reproduction correction unit for correcting an image signal formed by an imaging element according to a color reproduction matrix; a color reproduction matrix storage unit for storing a registered color reproduction matrix or an inverse matrix of the registered color reproduction matrix for each light source coordinates in a color space; and a color reproduction matrix calculation unit for interpolating inverse matrices of registered color reproduction matrices corresponding to at least two light source coordinates stored in the color reproduction matrix storage unit according to estimated light source coordinates in the color space, which are obtained from the image signal, and calculating an inverse matrix of a result of the interpolation as the color reproduction matrix.

### PRIORITY

This application claims priority under 35 U.S.C. §119(a) to a patent application filed in the Japan Patent Office on Dec. 15, 2010 and assigned Serial No. 279790/2010 and a patent application filed in the Korean Patent Office on Nov. 25, 2011 and assigned Serial No. 10-2011-0124427, the entire disclosures of which are incorporated herein by reference.

### BACKGROUND OF THE INVENTION

1. Field of the Invention

The present invention relates generally to an image processing apparatus, an image processing method, and a program recording medium.

2. Description of the Related Art

Recently, an electronic imaging device for forming an optical image of an object has come into use. Such a device forms an image on a light-receiving surface of an imaging element, such as a Charge Coupled Device (CCD), a Complementary Metal-Oxide Semiconductor (CMOS), and the like, through an imaging lens. The imaging device includes a white balance correction circuit for correcting an image signal consisting of imaged Red Green Blue (RGB) components such that a white object looks white irrespective of a light source color, and a color reproduction correction circuit for performing color correction with respect to the image signal to secure color reproduction.

In the white balance correction circuit, for R=G=B (i.e., the values of R, G, and B being achromatic colors), white balance gains Kr, Kg, and Kb are generally multiplied to input RGB signals, as shown in Equation (1) below.

R′=R×Kr

G′=G×Kg

B′=B×Kb (1)

Further, in the white balance correction circuit, white-balance corrected RGB signals R′, G′, and B′ are multiplied by a Color Correction Matrix (CCM) composed of three rows and three columns, as shown in Equation (2) below.

$$( \begin{matrix}{R}^{″} \\ {G}^{″} \\ {B}^{″}\end{matrix} ) = ( \begin{matrix}cc 00 & cc 01 & cc 02 \\ cc 10 & cc 11 & cc 12 \\ c 20 & c 21 & c 22\end{matrix} ) ( \begin{matrix}{R}^{′} \\ {G}^{′} \\ {B}^{′}\end{matrix} ) \qquad ( 2 )$$

In the imaging device, a CCM optimized for a particular light source is mostly registered in advance, such that the color reproduction correction circuit performs color correction by multiplying the registered CCM to the RGB signals. However, the registered CCM is the optimized CCM for a light source different from an actual light source, making it difficult to reproduce color well. In this regard, a technique for estimating coordinates of the actual light source in photographing and calculating a CCM according to the estimated light source coordinates has been proposed. For example, such a technique is disclosed in a previously published Japan Patent Publication No. 2006-270135.

However, in the conventional technique, the previously registered CCM is linear-interpolated based on the estimated light source coordinates, and color reproduction processing is performed by using the CCM obtained by linear interpolation, making it difficult to make a color reproduction of an output image.

### SUMMARY OF THE INVENTION

Therefore, the present invention has been made considering the above problem, and the present invention provides an imaging processing apparatus, an imaging processing method and a program recording medium, in which a color reproduction matrix corresponding to a light source color can be calculated with high precision.

According to an aspect of the present invention, an image processing apparatus is provided. The apparatus includes The image processing apparatus includes a color reproduction correction unit for correcting an image signal formed by an imaging element according to a color reproduction matrix; a color reproduction matrix storage unit for storing a registered color reproduction matrix or an inverse matrix of the registered color reproduction matrix for each light source coordinates in a color space; and a color reproduction matrix calculation unit for interpolating inverse matrices of registered color reproduction matrices corresponding to at least two light source coordinates stored in the color reproduction matrix storage unit according to estimated light source coordinates in the color space, which are obtained from the image signal, and calculating an inverse matrix of a result of the interpolation as the color reproduction matrix.

According to another aspect of the present invention, an image processing method is provided. The method includes storing a registered color reproduction matrix or an inverse matrix of the registered color reproduction matrix for each light source coordinates in a color space; interpolating inverse matrices of registered color reproduction matrices corresponding to at least two stored light source coordinates according to estimated light source coordinates in the color space, which are obtained from an image signal formed by an imaging element, and calculating an inverse matrix of a result of the interpolation as a color reproduction matrix; and correcting the image signal according to the calculated color reproduction matrix.

According to another aspect of the present invention, a recording medium having recorded thereon a program for performing an image processing method is provided. The method includes storing a registered color reproduction matrix or an inverse matrix of the registered color reproduction matrix for each light source coordinates in a color space; interpolating inverse matrices of registered color reproduction matrices corresponding to at least two stored light source coordinates according to estimated light source coordinates in the color space, which are obtained from an image signal formed by an imaging element, and calculating an inverse matrix of a result of the interpolation as a color reproduction matrix; and correcting the image signal according to the calculated color reproduction matrix.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating an image processing apparatus according to an embodiment of the present invention;

FIG. 2 is a diagram illustrating a dataflow in an image processing apparatus;

FIG. 3 is a diagram illustrating a plot in a coordinate system in which RGB ratios of light sources having different color temperatures are standardized to G=1.0;

FIG. 4 is a diagram illustrating a relationship between Distance (D) and Time (T);

FIG. 5 is a diagram illustrating a detailed example of registered light source information;

FIG. 6 is a diagram in which a distance from a reference light source, e.g., 5500K (K represents Kelvin, color temperature), to each registered light source is illustrated in the form of a concentric circle;

FIG. 7 is a diagram illustrating a ratio of distances between registered light sources and an estimated light source;

FIG. 8 is a diagram illustrating registered light source information stored in a color reproduction matrix storage unit;

FIG. 9 is a flowchart illustrating the steps of an image processing apparatus according to an embodiment of the present invention;

FIG. 10 is a diagram illustrating a plot in a coordinate system in which R gains (RGain) of white balance gains of light sources having different color temperatures correspond to an X axis and B gains (BGain) thereof correspond to a Y axis;

FIG. 11 is a diagram for showing CCM interpolation;

FIG. 12 is a diagram showing concrete values of each plot; and

FIG. 13 is a diagram illustrating coordinates q indicating an estimated light source and coordinates a and b of registered light sources for an interpolation computation.

### DETAILED DESCRIPTION OF EMBODIMENTS OF THE PRESENT INVENTION

Hereinafter, embodiments of the present invention will be described with reference to the accompanying drawings. Throughout the drawings, the same elements will be designated by the same reference numerals

### 1. STRUCTURE OF THE IMAGE PROCESSING APPARATUS

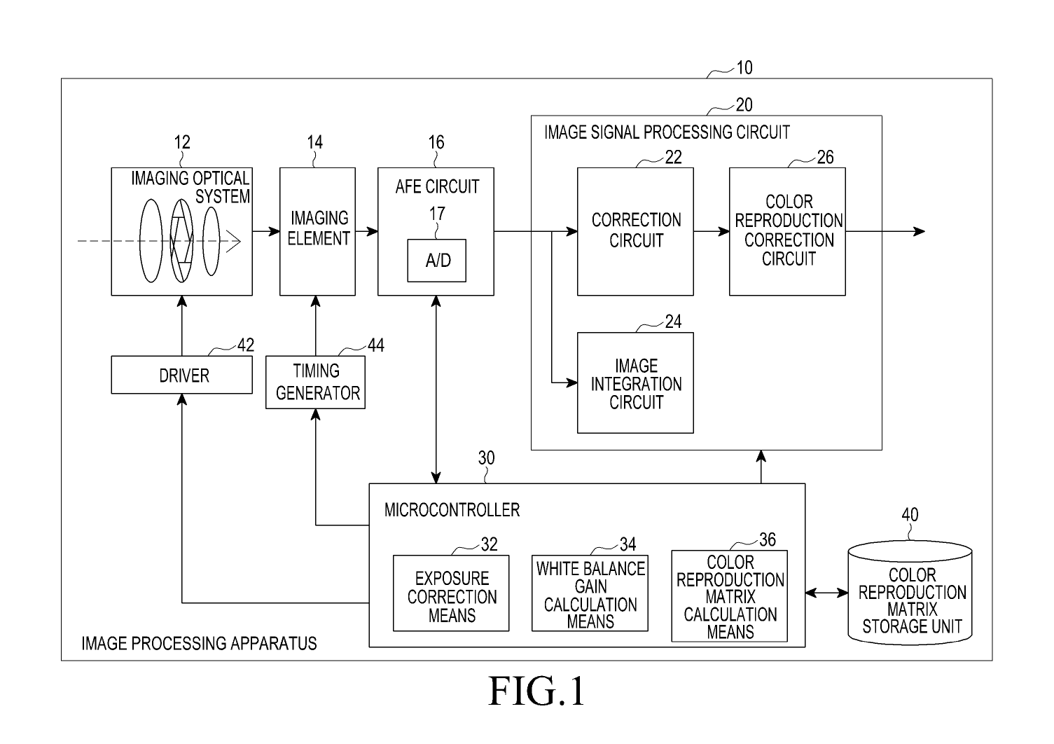

First, the overall structure of an image processing apparatus 10 according to an embodiment of the present invention will be described with reference to FIG. 1.

FIG. 1 is a block diagram illustrating a structure of the image processing apparatus 10 according to an embodiment of the present invention. As shown in FIG. 1, the image processing apparatus 10 may include an imaging optical system 12, an imaging element 14, an Analog Front End (AFE) circuit 16, an image signal processing circuit 20, a microcontroller 30, a color reproduction matrix storage unit 40, a driver 42, and a timing generator 44.

The imaging optical system 12 includes a plurality of imaging lenses or aperture apparatuses, and forms an optical image of an object on a light-receiving surface of the imaging element 14. The plurality of imaging lenses or aperture apparatuses are controlled by a driver 42 controlled by the microcontroller 30.

The imaging element 14 converts the optical image of the object formed on the light-receiving surface into an electric signal based on timing generated by the timing generator 44. The imaging element 14 may be a Complementary Metal-Oxide Semiconductor (CMOS) imaging element or a Charge Coupled Device (CCD) imaging element.

The AFE circuit 16 includes an Analog-to-Digital (A/D) converter 17 to perform A/D conversion of the image signal obtained by the imaging element 14. Red-Green-Blue (RGB) image signals converted into a digital format by the AFE circuit 16 are provided to the image signal processing circuit 20.

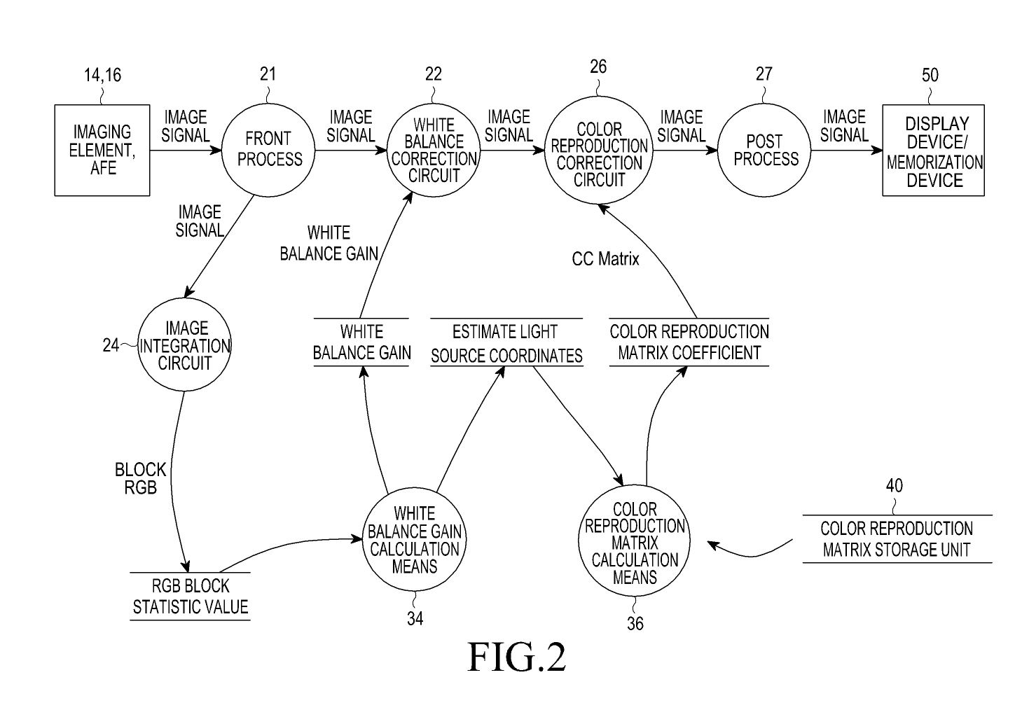

The image signal processing circuit 20 includes a white balance correction circuit 22, an image integration circuit 24, and a color reproduction correction circuit 26 to correct and output the RGB image signals. Each component of the image signal processing circuit 20 will be described in detail later with reference to FIG. 2.

The microcontroller 30 includes an exposure correction means 32, a white balance gain calculation means 34, and a color reproduction matrix calculation means 36 to control the overall operation of the image processing apparatus 10. Each component of the microcontroller 30 will be described in detail later with reference to FIG. 2.

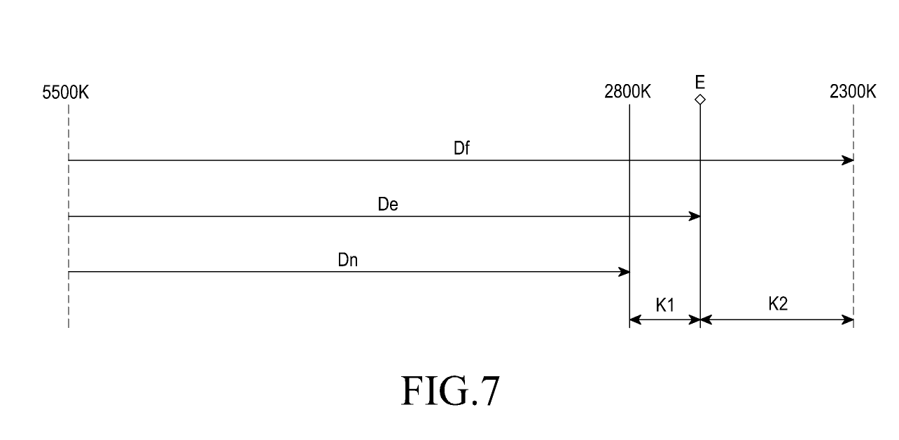

The color reproduction matrix storage unit 40 stores a combination of light source coordinates on a color space and a Color Correction Matrix (CCM) as registered light source information (CCM seed). The color reproduction matrix storage unit 40 also a combination of a distance from reference coordinates and an Inverse CCM (ICCM) of a CCM as registered light source information (the CCM seed) as shown in FIG. 7.

The image processing apparatus 10 calculates a color reproduction matrix having high precision through the color reproduction matrix calculation means 36 and performs an operation using the color reproduction matrix through the color reproduction correction circuit 26. Hereinafter, a data flow for color reproduction correction in the image processing apparatus 10 will be described with reference to FIG. 2.

### 2. DATA FLOW IN IMAGE PROCESSING APPARATUS

FIG. 2 is a diagram illustrating data flow in the image processing apparatus 10. As shown in FIG. 2, an image signal provided from the imaging element 14 and the AFE circuit 16 is processed, for example, in the following order:

(1) Pre-processing such as defective pixel correction and black level correction is performed in a front process 21;

(2) A white balance is corrected in the white balance correction circuit.

(3) Bayer color interpolation is performed in a Bayer demosaic circuit (not shown),

(4) Color correction processing is performed based on a color reproduction matrix in the color reproduction correction circuit 26;

(5) Post-processing such as gamma correction and YUV conversion is performed in a post process 27;

(6) Display/recording is performed in a display device/storing device 50.

The image signal pre-processed in the front process 21 is divided into N×M blocks in the image integration circuit 24, and an RGB statistic value per block is provided to the white balance gain calculation means 34.

The white balance gain calculation means 34 makes a determination such as, for example, regarding a chromatic color or an achromatic color, and calculates a white balance gain for use in the white balance correction circuit 22. A reciprocal of the white balance gain may be handled as an RGB balance (light source color RGB ratio) of a light source, that is, estimated light source coordinates in a color space.

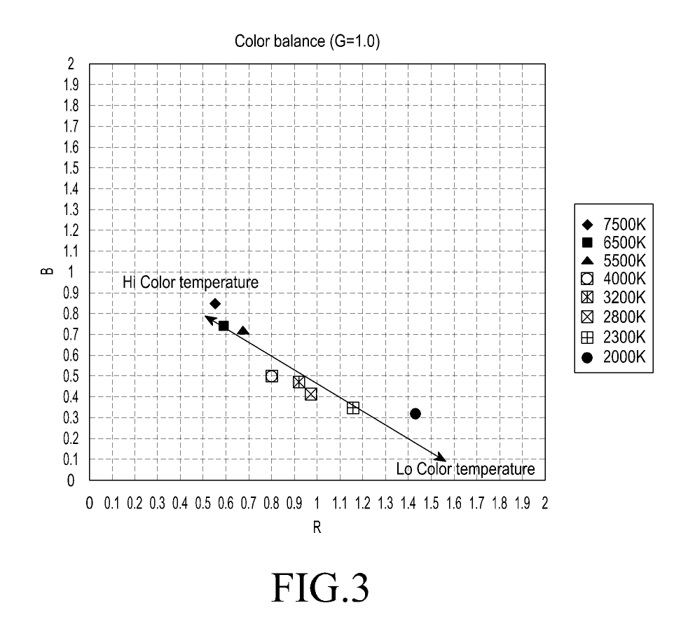

The color reproduction matrix calculation means 36 dynamically calculates a CCM based on the estimated light source coordinates and the registered light source information stored for each light source coordinates in the color reproduction matrix storage unit 40. Prior to describing a CCM calculation method executed by the color reproduction matrix calculation means 36, the registered light source information (CCM seed) stored in the color reproduction matrix storage unit 40 will be described with reference to FIG. 3.

### Registered Light Source Information

FIG. 3 is a diagram illustrating a plot in a coordinate system in which RGB ratios of light sources having different color temperatures are standardized to G=1.0. For the RGB ratio of the light source, a reciprocal of a white balance gain is used. As shown in FIG. 3, in a plot coordinate system, a change from a light source having a high color temperature to a light source having a low color temperature corresponds to a change from a point on the top left to point on the bottom right. The color reproduction matrix storage unit 40 may store, for example, a combination of plot coordinates in the coordinate system and a CCM as registered light source information (CCM seed).

The color reproduction matrix storage unit 40 may express light source coordinates by using a distance from reference coordinates (e.g., 5500K), and store a combination of the distance from the reference coordinates and a CCM as registered light source information (CCM seed). According to this configuration, the form of the registered light source information is simplified, thus speeding up processing and suppressing an excessive load caused by registering light source. As shown in FIG. 3, the plot coordinates of light sources having a plurality of color temperatures form an approximately straight line, such that it is thought that a small error will occur even when the distance from the reference coordinates is processed as light source coordinates.

A Euclidian distance from a reference light source having an RGB ratio of Rs to Bs to a light source having an RGB ratio of Rx to Bx is calculated using Equation (3):

Dx=\sqrt{(Rx−Rs)²+(Bx−Bs)²} (3)

However, only with the distance Dx, it is difficult to distinguish a light source having a color temperature higher than a reference light source from a light source having a color temperature lower than the reference light source. In this regard, by using a feature that a light source having a high color temperature has low R and high B and a light source having a low color temperature has high R and low B, if T is the distance from reference coordinates calculated using Equation (4) has a positive value, the light source may be determined to have the higher color temperature than the reference light source. If T has a negative value, the light source may be determined to have the lower color temperature than the reference light source. The color reproduction matrix storage unit 40 may store a combination of the distance D calculated using Equation (3), negative/positive information of T calculated using Equation (4), and a CCM as registered light source information (CCM seed).

T=(Rx−Bx)−(Rs−Bs) (4)

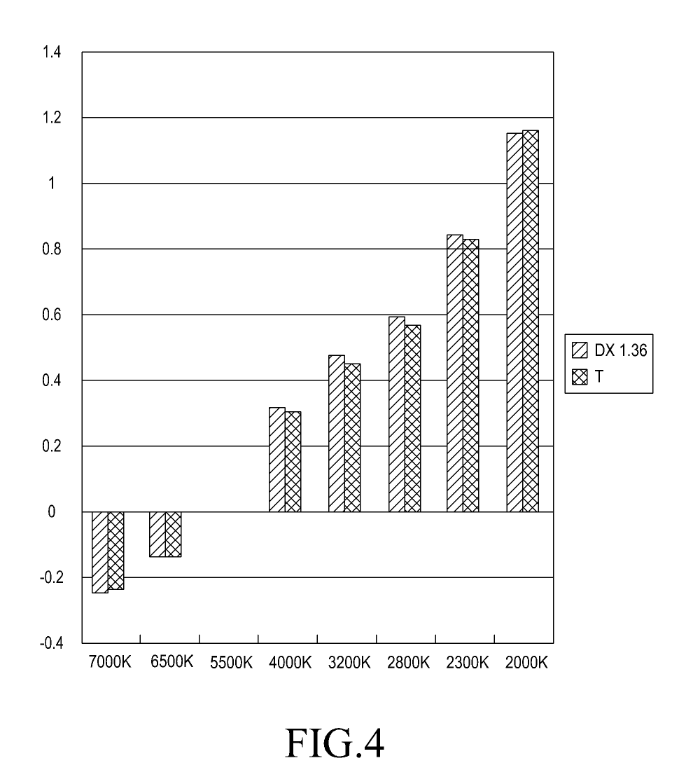

A relationship between the distance D calculated using Equation (3) and T calculated using Equation (4) for each color temperature is shown in FIG. 4. As shown in FIG. 4, a difference between D and T is small. Thus, the color reproduction matrix storage unit 40 may handle T calculated using Equation (4) as a distance from reference coordinates and store a combination of T and a CCM as registered light source information (CCM seed).

In the color reproduction matrix calculation means 36, a CCM for color reproduction is calculated using an inverse matrix of a CCM of light source coordinates. For this reason, the color reproduction matrix storage unit 40 may store a combination of the distance T from reference coordinates and a CCM for each registered light source as registered light source information (CCM seed). According to this configuration, it is not necessary for the color reproduction matrix calculation means 36 to calculate the inverse matrix of the CCM, and thus a load in the color reproduction matrix calculation means 36 can be reduced.

### 3. CCM CALCULATION METHOD

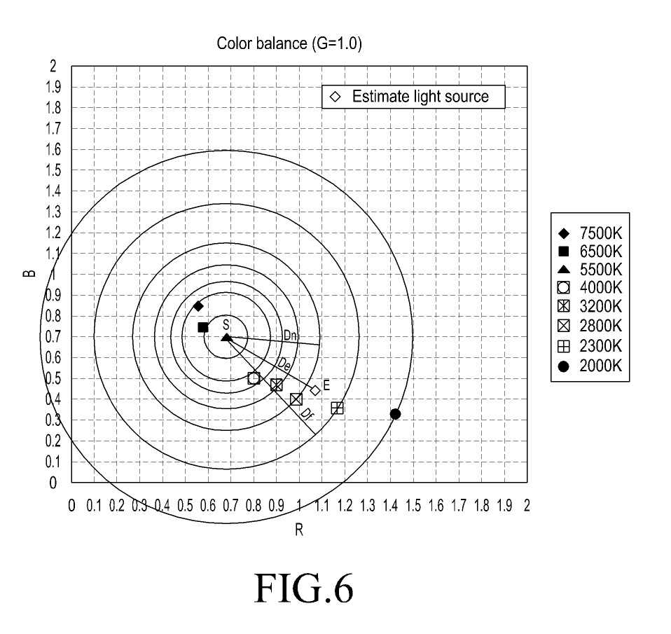

Referring to FIGS. 6 and 7, a method for the color reproduction matrix calculation means 36 to calculate a CCM of an estimated light source E will be described below.

FIG. 6 is a diagram in which a distance from a reference light source, e.g., 5500K, to each registered light source is shown in the form of a concentric circle. The color reproduction matrix calculation means 36 calculates a distance De between the reference light source and the estimated light source E to calculate the CCM of the estimated light source E in FIG. 6. For example, the color reproduction matrix calculation means 36 may calculate the distance De between the reference light source and the estimated light source E by using Equation (4).

The color reproduction matrix calculation means 36 compares distance information of the registered light source information with the distance De to select at least two registered light sources in the vicinity of the estimated light source E. In an example shown in FIG. 6, the color reproduction matrix calculation means 36 selects a registered light source, e.g., 2300K, having a distance Df from the reference light source and a registered light source, e.g., 2800K, having a distance Dn from the reference light source.

The color reproduction matrix calculation means 36 calculates a ratio of k₁, k₂ shown in FIG. 7, i.e., a ratio of distances between the two selected registered light sources and the estimated light source E, by using Equation (5) and Equation (6).

$$\begin{matrix}{k}_{1} = \frac{( De - Dn )}{( Df - Dn )} & ( 5 ) \\ {k}_{2} = \frac{( Df - De )}{( Df - Dn )} & ( 6 )\end{matrix}$$

The color reproduction matrix calculation means 36 performs interpolation by weighted averaging of an inverse matrix of a CCM a of 2800K, which is expressed as Equation (7), and an inverse matrix of a CCM b of 2300K, which is expressed as Equation (8), according to k₁ and k₂, as expressed as Equation (9). The color reproduction matrix calculation means 36 performs an operation with respect to an inverse matrix of an ICCM q, which is the result of interpolation given by Equation (9), as expressed as Equation (10), thereby calculating a color reproduction matrix CCM q of an estimated light source.

$$\begin{matrix}\begin{matrix} CCM & a\end{matrix} = [ \begin{matrix}{C}_{00} , {C}_{01} , {C}_{02} \\ {C}_{10} , {C}_{11} , {C}_{12} \\ {C}_{20} , {C}_{21} , {C}_{22}\end{matrix} ] & ( 7 ) \\ \begin{matrix} CCM & b\end{matrix} = [ \begin{matrix}{C}_{30} , {C}_{31} , {C}_{32} \\ {C}_{40} , {C}_{41} , {C}_{42} \\ {C}_{50} , {C}_{51} , {C}_{52}\end{matrix} ] & ( 8 ) \\ {ICCM}_{q} = {[ \begin{matrix}{C}_{00} , & {C}_{01} , & {C}_{02} \\ {C}_{10} & {C}_{11} & {C}_{12} \\ {C}_{20} & {C}_{21} & {C}_{22}\end{matrix} ]}^{- 1} \times [ \begin{matrix}{k}_{2} , & 0 , & 0 \\ 0 , & {k}_{2} & 0 \\ 0 , & 0 , & {k}_{2}\end{matrix} ] + {[ \begin{matrix}{C}_{30} , & {C}_{31} , & {C}_{32} \\ {C}_{40} , & {C}_{41} , & {C}_{42} \\ {C}_{50} , & {C}_{51} , & {C}_{52}\end{matrix} ]}^{- 1} \times [ \begin{matrix}{k}_{1} , & 0 , & 0 \\ 0 , & {k}_{1} , & 0 \\ 0 , & 0 , & {k}_{1}\end{matrix} ] & ( 9 ) \\ \begin{matrix} CCM & q\end{matrix} = {[ \begin{matrix}ICCM & q\end{matrix} ]}^{- 1} & ( 10 )\end{matrix}$$

The color reproduction correction circuit 26 multiplies the color reproduction matrix CCM q calculated by the color reproduction matrix calculation means 36 to the image signal, thereby securing color reproduction of the output image.

### 4. EXAMPLE OF CALCULATION OF CCM BY USING CONCRETE VALUES

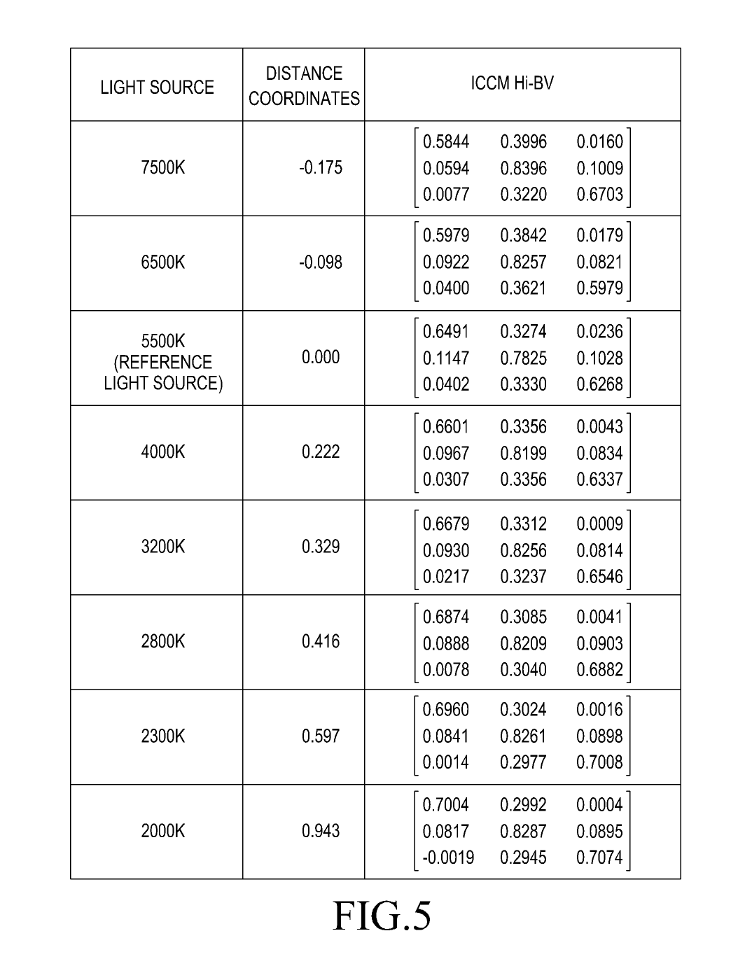

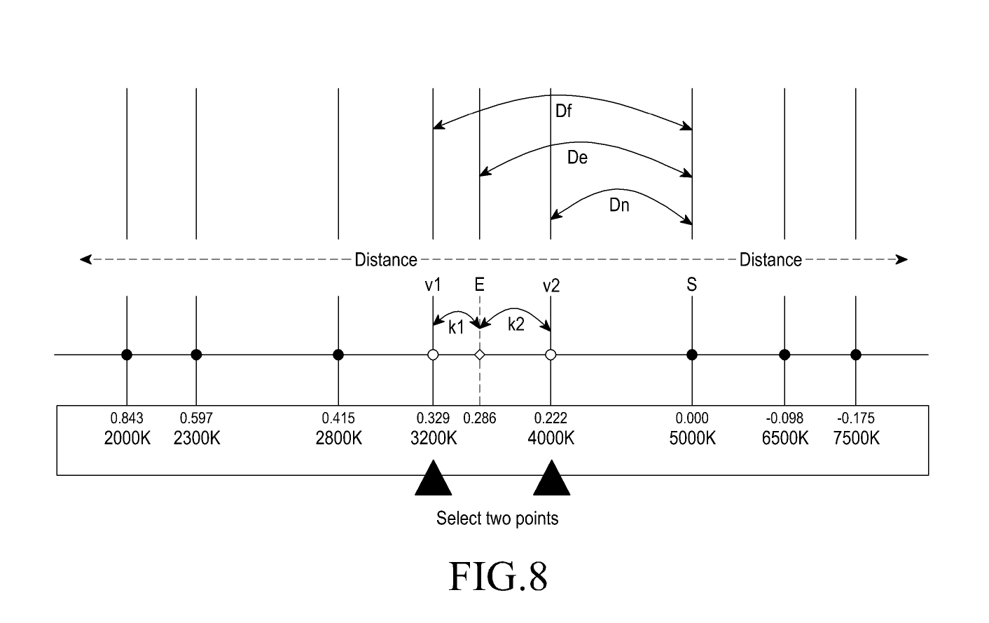

FIG. 8 is a diagram illustrating registered light source information (shown in FIG. 5) stored in the color reproduction matrix storage unit 40. In the following description, concrete values will be used to describe an example of calculation of a CCM of the estimated light source E shown in FIG. 8.

The color reproduction matrix calculation means 36 calculates the distance De from the reference light source to the estimated light source E according to, for example, Equation (4). It is assumed that the distance De is calculated as 0.286 as shown in FIG. 8.

The color reproduction matrix calculation means 36 selects a registered light source 3200K longer than 0.286 and a registered light source 4000K shorter than 0.286.

The color reproduction matrix calculation means 36 calculates a distance ratio of k₁ and k₂ according to Equation (5) and Equation (6), and performs ICCM interpolation computation by using the calculated distance ratio of k₁ and k₂. More specifically, an ICCM of 3200K and an ICCM of 4000K are weighted-averaged at a ratio of k₂:k₁.

The color reproduction matrix calculation means 36 obtains an inverse matrix of the ICCM of the estimated light source E, obtained by weighted-averaging, and outputs the inverse matrix of the ICCM as a CCM of the estimated light source E.

In ICCM interpolation computation, if the estimated light source E is out of a range of coordinates of a registered light source stored in the color reproduction matrix storage unit 40, a CCM of a registered light source corresponding to a lower limit or an upper limit is output. For example, if the estimated light source E is lower than the lowest value (−0.175) of distance information regarding the registered light source, a CCM of 7500K may be fixed as a CCM of the estimated light source E. Similarly, the estimated light source E is greater than the highest value (0.843) of the distance information regarding the registered light source, a CCM of 2000K may be fixed as a CCM of the estimated light source E.

### 5. OPERATIONS OF IMAGE PROCESSING APPARATUS

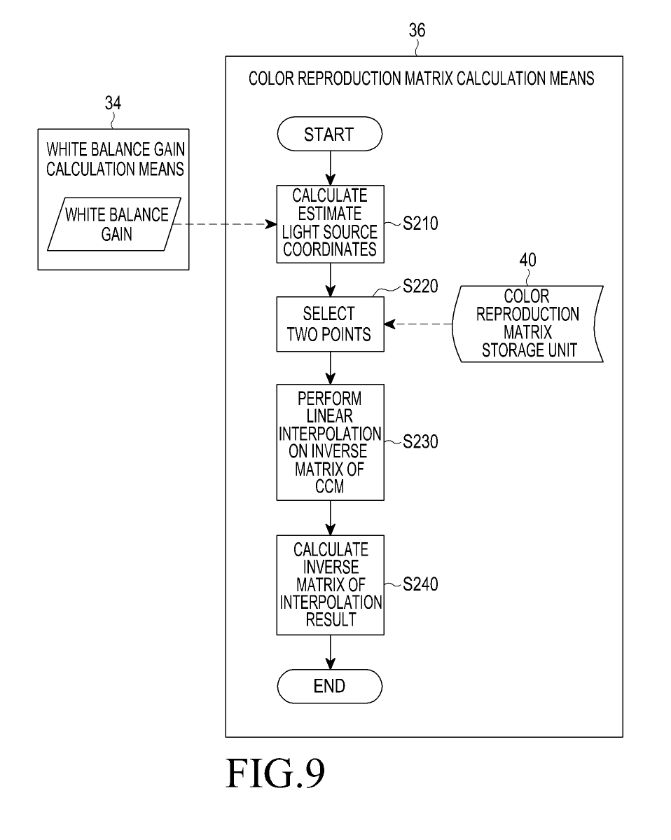

The structure and data flow of the image processing apparatus 10 of FIG. 1 have been described so far. The operations of the image processing apparatus 10 will now be described with reference to FIG. 9.

FIG. 9 is a flowchart illustrating operations of the image processing apparatus 10 according to an embodiment of the present invention. As shown in FIG. 9, the color reproduction matrix calculation means 36 calculates an RGB ratio, which is a reciprocal of a white balance gain, as estimated light source coordinates in step S210. In step S220, the color reproduction matrix calculation means 36 then selects two registered light source coordinates (two points) in the vicinity of estimated light source coordinates from registered light source information stored in the color reproduction matrix storage unit 40.

The color reproduction matrix calculation means 36 performs linear interpolation with respect to an inverse matrix of a CCM (ICCM) of the selected two points according to a ratio of distances between an estimated light source and the two points in step S230. The color reproduction matrix calculation means 36 calculates an inverse matrix of the interpolation result, thus obtaining a CCM of the estimated light source in step S240. The obtained CCM is used for color reproduction correction in the color reproduction correction circuit 26.

### 6. EFFECTS OF CURRENT EMBODIMENT

The effects of a case where an ICCM of a registered light source, instead of a CCM of the registered light source will be described.

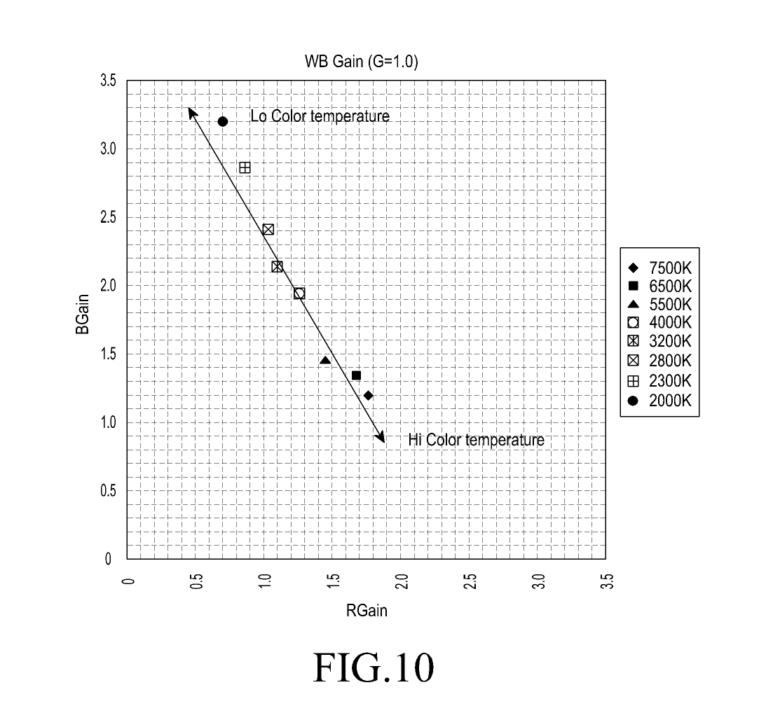

FIG. 10 is a diagram illustrating a plot in a coordinate system in which R gains (RGain) of white balance gains of light sources having different color temperatures correspond to an X axis and B gains (BGain) thereof correspond to a Y axis. As shown in FIG. 10, by referring to a white balance gain, a light source color in photographing can be reasonably determined.

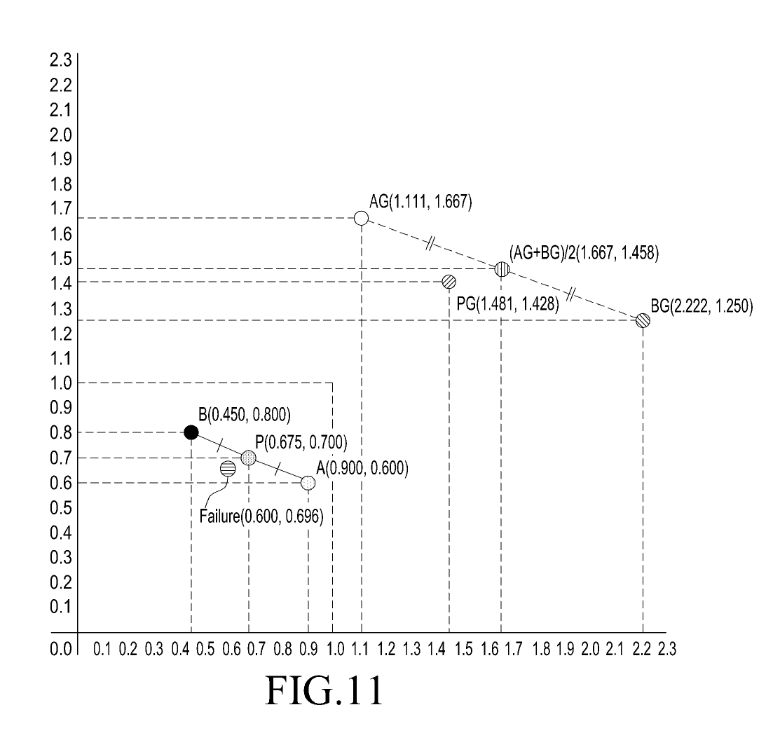

In the following description, a method for interpolating ICCMs of two registered light sources in the vicinity of the estimated light source based on the white balance gain will be described by referring to FIG. 11.

FIG. 11 is a diagram for explaining CCM interpolation. As shown in FIG. 11, a white balance gain of a registered light source A is indicated by coordinates AG, a white balance gain of a registered light source B is indicated by coordinates BG, and the registered light sources A and B are assumed to be selected as light sources in the vicinity of an estimated light source.

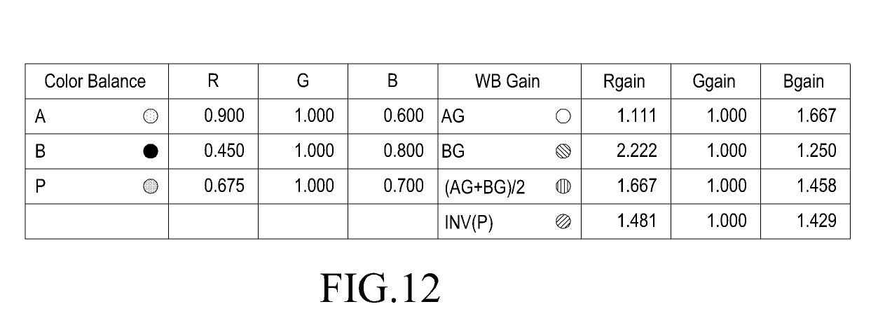

RGB ratios of the registered light sources A and B are reciprocals of white balance gains of the registered light sources A and B, respectively, and thus are coordinates A and coordinates B. Exact values of each coordinates are as shown in FIG. 12.

An RGB ratio of an intermediate light source between the registered light source A and the registered light source B is indicated by coordinates P calculated by (A+B)/2, and a white balance gain of the intermediate light source is indicated by coordinates PG, which are reciprocals of the coordinates P.

While (AG+BG)/2 is shown in FIG. 11 by using the white balance gain AG of the registered light source A and the white balance gain BG of the registered light source B, (AG+BG)/2 does not match the coordinates PG of the white balance gain of the intermediate light source. In addition, a light source indicated by a reciprocal of (AG+BG)/2 has coordinates indicated by “Failure” in FIG. 11.

From the above description, after the white balance gain is standardized to, for example, G=0.1, an RGB ratio, which is a reciprocal thereof, is calculated such that the RGB ratio can be evaluated with a coordinate system in which R/G corresponds to an X axis and B/G corresponds to a Y axis. Since a correct value cannot be obtained by performing interpolation computation with respect to the gain, it would be more effective to perform interpolation computation with respect to the RGB ratio.

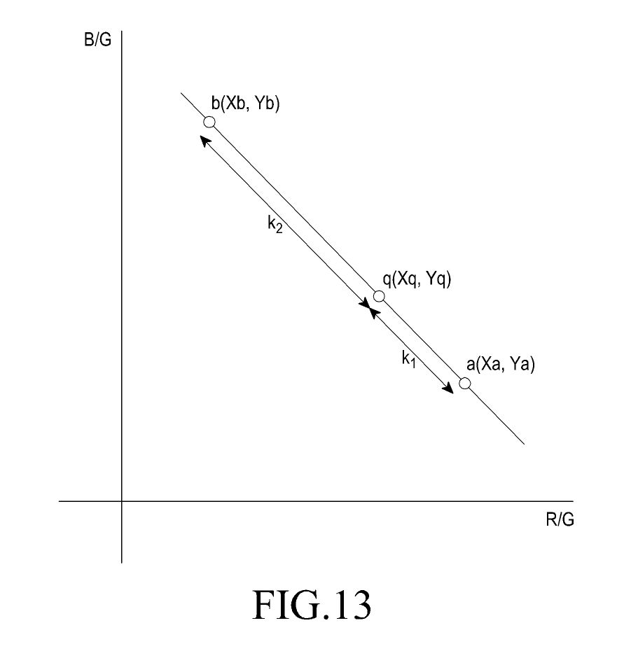

Interpolation of a CCM will be described with reference to FIG. 13.

FIG. 13 is a diagram illustrating coordinates q indicating an estimated light source and coordinates a and b of registered light sources for interpolation computation. The coordinates q indicating the estimated light source may be obtained, for example, as a reciprocal of a white balance gain. Interpolation of a CCM of the coordinates q according to a distance ratio of the coordinates q and the registered light sources a and b in the vicinity of the coordinates q in a conventional manner will be described.

In the conventional manner, a CCM a optimized for the coordinates a, which is expressed as Equation (11), and a CCM b optimized for the coordinates b, which is expressed as Equation (12), are linearly interpolated according to the distance ratio of k₁ and k₂, as expressed as Equation (13), thus calculating a CCM q.

$$\begin{matrix}\begin{matrix} CCM & a = [ \begin{matrix}{C}_{00} , {C}_{01} , {C}_{02} \\ {C}_{10} , {C}_{11} , {C}_{12} \\ {C}_{20} , {C}_{21} , {C}_{22}\end{matrix} ]\end{matrix} & ( 11 ) \\ \begin{matrix} CCM & b = [ \begin{matrix}{C}_{30} , {C}_{31} , {C}_{32} \\ {C}_{40} , {C}_{41} , {C}_{42} \\ {C}_{50} , {C}_{51} , {C}_{52}\end{matrix} ]\end{matrix} & ( 12 ) \\ \begin{matrix}CCM & q\end{matrix} = {[ \begin{matrix}{C}_{00} , {C}_{01} , {C}_{02} \\ {C}_{10} , {C}_{11} , {C}_{12} \\ {C}_{20} , {C}_{21} , {C}_{22}\end{matrix} ]}^{- 1} \times [ \begin{matrix}{k}_{2} , 0 , 0 \\ 0 , {k}_{2} , 0 \\ 0 , 0 , {k}_{2}\end{matrix} ] + {[ \begin{matrix}{C}_{30} , {C}_{31} , {C}_{32} \\ {C}_{40} , {C}_{41} , {C}_{42} \\ {C}_{50} , {C}_{51} , {C}_{52}\end{matrix} ]}^{- 1} \times [ \begin{matrix}{k}_{1} , 0 , 0 \\ 0 , {k}_{1} , 0 \\ 0 , 0 , {k}_{1}\end{matrix} ] & ( 13 )\end{matrix}$$

However, as mentioned above, even if interpolation computation is performed with respect to the white balance gain, a proper result cannot be obtained. Similarly, a CCM is a 3×3 matrix, but it is also a type of gain. The white balance gain can be expressed as the 3×3 matrix as shown in Equation (14) below:

$$WBGain = [ \begin{matrix}RG , & 0 , & 0 \\ 0 , & GG , & 0 \\ 0 , & 0 , & BG\end{matrix} ] \qquad ( 14 )$$

From the above description, also for a CCM, a correct result cannot be obtained if interpolation computation is not performed after a reciprocal (inverse matrix) is obtained. That is, a correct interpolation result cannot be obtained merely with an operation expressed as Equation (13).

Therefore, in the current embodiment, as shown in Equation (9), inverse matrices of the CCM a and the CCM b are obtained and then interpolation computation is performed, thereby obtaining the ICCM q, and as shown in Equation (10), the inverse matrix of the ICCM q is obtained, thereby obtaining the CCM q of high precision.

### 7. COMPLEMENT

While an embodiment of the invention has been described in detail with reference to the accompanying drawings, the present invention is not limited to the embodiment. It will be apparent to those skilled in the art that various changes or modifications may be made within the scope of the technical spirit disclosed in the appended claims and their equivalents.

For example, while a CCM has been calculated using a color space standardized mainly based on an RGB ratio, the present invention is not limited thereto. CCM may also be calculated in the same manner by using a standardized color space such as Yxy, Lab, and the like.

Additionally, each step in processing of the image processing apparatus 10 disclosed in the current specification does not need to be time-serially processed in the order shown in the flowcharts. For example, each step of the image processing apparatus 10 may be performed in an order different from that shown in a flowchart or may be performed in parallel.

Hardware embedded in the image processing apparatus 10, such as a Central Processing Unit (CPU), a Read Only Memory (ROM), a Random Access Memory (RAM), and the like, may be embodied as computer programs for executing functions equivalent to those of components of the image processing apparatus 10. Moreover, a storing medium for storing those computer programs may be used.

Thus, a color reproduction matrix corresponding to a light source color can be calculated with high precision.

What is claimed is:

1. An image processing apparatus, the apparatus comprising:
a color reproduction correction unit for correcting an image signal formed by an imaging element according to a color reproduction matrix;
a color reproduction matrix storage unit for storing a registered color reproduction matrix or an inverse matrix of the registered color reproduction matrix for each light source coordinates in a color space; and
a color reproduction matrix calculation unit for interpolating inverse matrices of registered color reproduction matrices corresponding to at least two light source coordinates stored in the color reproduction matrix storage unit according to estimated light source coordinates in the color space, which are obtained from the image signal, and calculating an inverse matrix of a result of the interpolation as the color reproduction matrix.

2. The image processing apparatus of claim 1, further comprising:
a white balance correction unit for correcting the image signal according to a white balance gain; and
a white balance gain calculation unit for calculating the white balance gain,
wherein the color reproduction matrix calculation unit processes a reciprocal of the white balance gain as the estimated light source coordinates.

3. The image processing apparatus of claim 2, wherein the color reproduction matrix calculation unit performs interpolation by selecting at least two light source coordinates in the vicinity of the estimated light source coordinates from among light source coordinates stored in the color reproduction matrix storage unit, and performing weighted-averaging of the inverse matrices of the registered color reproduction matrices, which correspond to the at least two selected light source coordinates according to a positional relationship between the estimated light source coordinates and the at least two light source coordinates.

4. The image processing apparatus of claim 3, wherein the color reproduction matrix calculation unit performs interpolation by calculating a distance ratio of the estimated light source coordinates and the at least two selected light source coordinates in the color space, and performing weighted-averaging of the inverse matrices of the registered color reproduction matrices according to the distance ratio.

5. The image processing apparatus of claim 4, wherein the color reproduction matrix calculation unit calculates the distance ratio of distances to the at least two light source coordinates and a distance to the estimated light source coordinates from reference coordinates.

6. An image processing method, the method comprising:
storing a registered color reproduction matrix or an inverse matrix of the registered color reproduction matrix for each light source coordinates in a color space;
interpolating inverse matrices of registered color reproduction matrices corresponding to at least two stored light source coordinates according to estimated light source coordinates in the color space, which are obtained from an image signal formed by an imaging element, and calculating an inverse matrix of a result of the interpolation as a color reproduction matrix; and
correcting the image signal according to the calculated color reproduction matrix.

7. The image processing method of claim 6, further comprising:
correcting the image signal according to a white balance gain and calculating the white balance gain, by processing a reciprocal of the white balance gain as the estimated light source coordinates.

8. The image processing method of claim 6, wherein interpolating the inverse matrices of the registered color reproduction matrices comprises selecting at least two light source coordinates in the vicinity of the estimated light source coordinates from among light source coordinates stored in the color reproduction matrix storage unit, and performing weighted-averaging of inverse matrices of registered color reproduction matrices, which correspond to the at least two selected light source coordinates according to a positional relationship between the estimated light source coordinates and the at least two light source coordinates.

9. The image processing method of claim 7, wherein interpolation is performed by calculating a distance ratio of the estimated light source coordinates to the at least two selected light source coordinates in the color space, and performing weighted-averaging of the inverse matrices of the registered color reproduction matrices according to the distance ratio.

10. The image processing method of claim 9, wherein calculating the distance ratio comprises calculating the distance ratio of distances to the at least two light source coordinates and a distance to the estimated light source coordinates from reference coordinates.

11. A recording medium having recorded thereon a program for performing an image processing method, the method comprising:
storing a registered color reproduction matrix or an inverse matrix of the registered color reproduction matrix for each light source coordinates in a color space;
interpolating inverse matrices of registered color reproduction matrices corresponding to at least two stored light source coordinates according to estimated light source coordinates in the color space, which are obtained from an image signal formed by an imaging element, and calculating an inverse matrix of a result of the interpolation as a color reproduction matrix; and
correcting the image signal according to the calculated color reproduction matrix.
